(19) United States
(12) Patent Application Publication
(10) Pub. No.: US 2008/0244731 A1
(43) Pub. Date: Oct. 2, 2008

(54) Thin client computer with fingerprint identification structure

(75) Inventor: Hung-Chieh Chang, Shijr City (TW)

Correspondence Address: TROXELL LAW OFFICE PLLC, SUITE 1404, 5205 LEESBURG PIKE, FALLS CHURCH, VA, 22041, US

(73) Assignee: Clientron Corp.

(21) Appl. No.: 11/730,356

(22) Filed: Mar. 30, 2007

(51) Int. Cl. H04L 9/32

(52) U.S. Cl. 726/17

(57) ABSTRACT

A thin client computer with a fingerprint identification structure of the present invention comprises a motherboard, a case, a faceplate and a fingerprint reader. The case is designed for holding the motherboard. The faceplate is placed to cover the case. The faceplate has a coupling hole on a lateral surface. The fingerprint reader is coupled into the coupling hole on the lateral surface of the faceplate, and connected with the motherboard for reading a fingerprint. The fingerprint reader is located on the lateral surface of faceplate in such a manner that the thin client computer can read the fingerprint easily no matter whether the thin client computer is placed horizontally or vertically. After verifying the fingerprint, the user is authorized to boot up or shut down the thin client computer.

### FIELD OF THE INVENTION

The present invention relates to a thin client computer with a fingerprint identification structure, and more particularly to a thin client computer that has a fingerprint reader mounted on a lateral surface of a faceplate in such a manner that the thin client computer can read a fingerprint easily no matter whether the thin client computer is placed horizontally or vertically.

### BACKGROUND OF THE INVENTION

Nowadays, almost all data such as files and documents were digitized and stored in computers. After booting up the computers and entering the operation system, all these non-encrypted or non-secured secret files or sensitive data will be easily obtained, copied or even stolen by other peoples. Accordingly, it is believed that the users will be ready to be provided with an easy and secure login technology to enhance security of all data stored in the computers.

The fingerprint reader is commonly, widely applied for personal identity verification. The advantage of applying the fingerprint to security verification consists in that there is no need to memorize the personal, non-sharable and uncopyable fingerprint as the secret codes so the problem of security can be really solved. At present, the fingerprint identification technology is mostly applied to the personal notebook computer, wherein the fingerprint reader is typically mounted on a keyboard of the computer or connected thereto via a USB interface.

The existing gradually popular small-size computers such as thin client computers and barebone computers are easy to carry so they need more security protections to protect the data in the computers against intruders. In view of this, the present inventor makes diligent studies in providing general public with a thin client computer with a fingerprint identification structure, wherein a fingerprint reader is coupled with the thin client computer to preclude the unauthorized user from booting up or shutting down the thin client computer. Accordingly, the thin client computer provides the user with space-saving advantage and also ensures the security of data.

### SUMMARY OF THE INVENTION

It is an object of the present invention to provide a thin client computer with a fingerprint identification structure, wherein a fingerprint reader is located on a lateral surface of a faceplate so that the thin client computer can read a fingerprint easily no matter whether it is placed horizontally or vertically, thereby increasing the practicability and the convenience.

It is another object of the present invention to provide a thin client computer with a fingerprint identification structure, wherein a fingerprint reader is connected with a motherboard of the thin client computer to enable the authorized user to boot up or shut down the thin client computer. Accordingly, the thin client computer provides the user with space-saving advantage and also ensures the security of data, thereby increasing overall practicability.

In order to achieve the foregoing and other objects, a thin client computer with a fingerprint identification structure of the present invention is comprised of a motherboard, a case, a faceplate and a fingerprint reader. The case is designed for holding the motherboard. The faceplate is placed to cover the case. The faceplate has a coupling hole formed on the lateral surface. The fingerprint reader is coupled into the coupling hole on the lateral surface of the faceplate, and connected with the motherboard for reading a fingerprint. The fingerprint reader is located on the lateral surface of faceplate so the thin client computer can read the fingerprint easily no matter whether the thin client computer is placed horizontally or vertically. After verifying the fingerprint, the user is authorized to boot up or shut down the thin client computer.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a preferred embodiment of the present invention.

FIG. 2 is an elevational, decomposed view showing the preferred embodiment of the present invention.

FIG. 3 is a schematic view showing the vertically-placed preferred embodiment of the present invention.

FIG. 4 is a schematic view showing the horizontally-placed preferred embodiment of the present invention.

### DETAILED DESCRIPTION OF THE PREFERRED EMBODIMENT

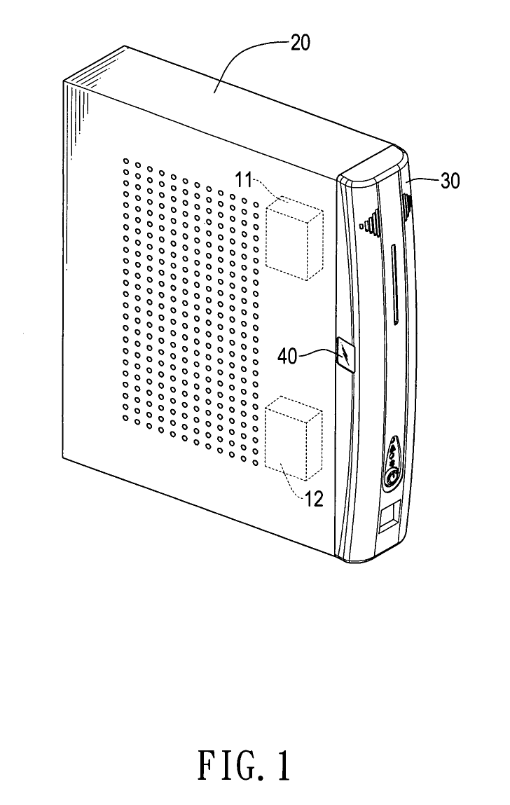

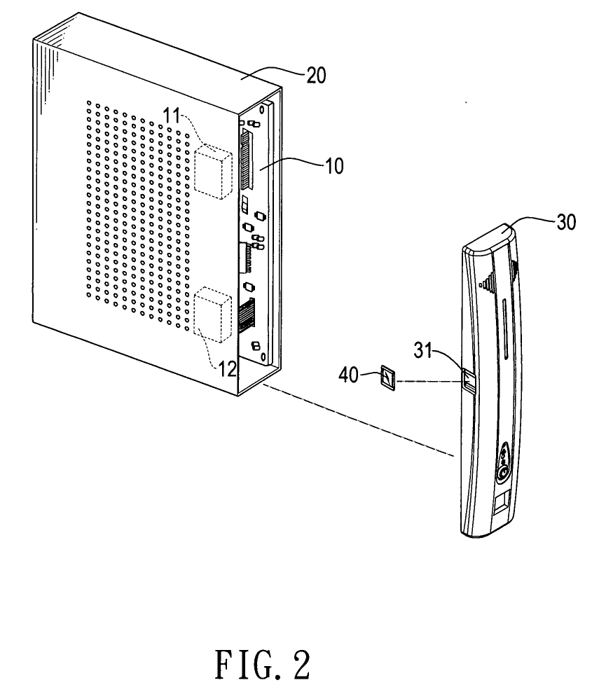

Referring to FIGS. 1 and 2, a thin client computer with a fingerprint identification structure of the present invention comprises a motherboard 10, a case 20, a faceplate 30 and a fingerprint reader 40.

The motherboard 10 has a data storage unit 11 and a fingerprint-processing unit 12 mounted thereon. The data storage unit 11 is designed for storing fingerprint data. The fingerprint-processing unit 12 is designed for comparing, identifying the fingerprint data stored in the data storage unit 11 so as to verify the user's identity.

The case 20 is designed for holding the motherboard 30. The faceplate 30 is placed to cover the case 20, and the faceplate 30 has a coupling hole 31 on the lateral surface.

The fingerprint reader 40 is coupled into the coupling hole 31 on the lateral surface of the faceplate 30, and connected with the motherboard 10 for reading the fingerprint. The fingerprint reader 40 is of an optical-type or a chip-type. The chip-type fingerprint reader is of a capacitive-type, a thermal-type, an electric field-type or a piezoelectric-type.

Referring to FIGS. 1 and 2, the present invention is featured in that the motherboard 10, the case 20, the faceplate 30 and the fingerprint reader 40 are assembled together. In addition, the fingerprint reader 40 couples into the coupling hole 31 formed on the lateral surface of the faceplate 30, and the faceplate 30 covers the case 20 so as to constitute the thin client computer with the identification structure. As a result, the thin client computer can read the fingerprint easily no matter whether the thin client computer is placed horizontally or vertically. In addition, after the fingerprint reader 40 acquires the user's fingerprint, the data of this fingerprint is stored in the data storage unit 11 of the motherboard 10. When the user desires to operate the computer again on a later day, the user needs to put his finger on the fingerprint reader 40 in such a manner that the fingerprint-processing unit 12 of the motherboard 10 performs the comparison and identification. After verifying this fingerprint, this user is authorized to boot up or shut down the thin client computer, thereby increasing its practicability and convenience.

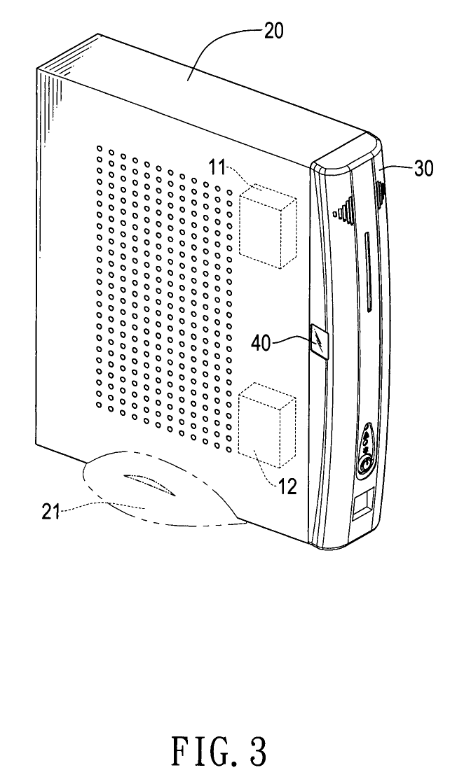

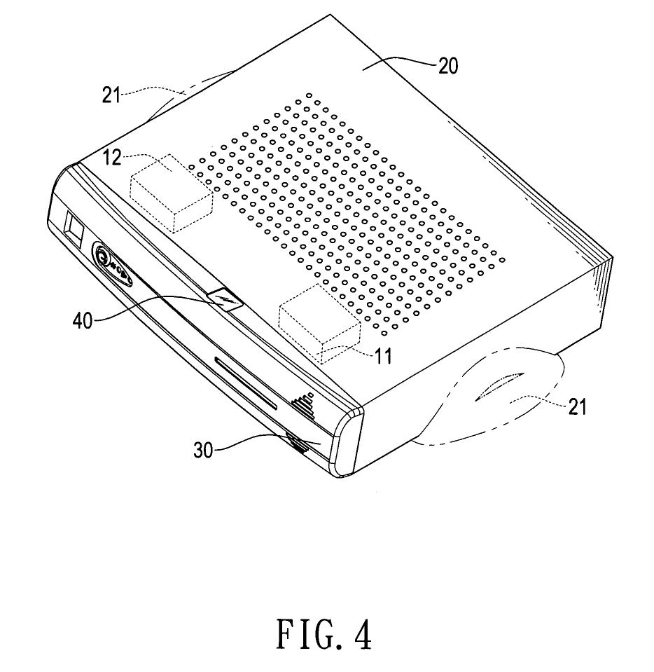

Referring to FIGS. 3 and 4, a stand 21 can be mounted under the case 20 to allow the thin client computer to be steadily placed in a vertical or horizontal status. Accordingly, the user can easily touch the fingerprint reader 40 no matter whether the thin client computer is placed horizontally or vertically. In order to operate the thin client computer, the user must first make registration to the thin client computer by acquiring the user's fingerprint via the fingerprint reader 40 and storing the data of this fingerprint in the data storage unit 11. When the user desires to operate the computer again on a later day, the user just needs to put his finger on the fingerprint reader 40 so that the fingerprint-processing unit 12 performs the comparison and identification for verifying the fingerprint. After verifying the fingerprint, the user is authorized to boot up or shut down the thin client computer. According to the present invention, the user's identity must be verified before he is authorized to boot up or shut down the thin client computer. Thus, the security of data is ensured, thereby increasing its practicability and convenience.

To sum up, the present invention discloses the thin client computer with the fingerprint identification structure capable of achieving the aforementioned objects. Thus, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A thin client computer with a fingerprint identification structure, comprising:
a motherboard;
a case for holding said motherboard;
a faceplate for covering said case, said faceplate having a coupling hole on a lateral surface; and
a fingerprint reader coupled into said coupling hole on said lateral surface of said faceplate, and said fingerprint reader being connected with said motherboard for reading a fingerprint, whereby said thin client computer can read said fingerprint easily no matter whether said thin client computer is placed horizontally or vertically so that said fingerprint can be verified to boot up or shut down said thin client computer.

2. A thin client computer with a fingerprint identification structure of claim 1, wherein said motherboard has a data storage unit and a fingerprint-processing unit mounted thereon.

3. A thin client computer with a fingerprint identification structure of claim 1, wherein said fingerprint reader is of an optical-type or a chip-type.

4. A thin client computer with a fingerprint identification structure of claim 3, wherein said chip-type fingerprint reader is of a capacitive-type, a thermal-type, an electric field-type or a piezoelectric-type.
